(19) United States
(12) Patent Application Publication
(10) Pub. No.: US 2019/0337731 A1
(43) Pub. Date: Nov. 7, 2019

(54) SHOE SORTER CONVEYOR

(71) Applicant: Bastian Solutions, LLC, Indianapolis, IN (US)

(72) Inventors: William A. Bastian, II, Carmel, IN (US); Benjamin Perry Baker, Indianapolis, IN (US); Ethan W. Cating, Fortville, IN (US); Daniel J. Hart, Westfield, IN (US)

(73) Assignee: Bastian Solutions, LLC, Indianapolis, IN (US)

(21) Appl. No.: 15/969,031

(22) Filed: May 2, 2018

(51) Int. Cl. B65G 47/28; B65G 47/88

(52) U.S. Cl. CPC B65G 47/28; B65G 2811/0657; B65G 47/88

(57) ABSTRACT

A sorter includes a slat and a shoe disposed along the slat. The shoe includes a base and a bumper. The base has an exterior surface. The bumper is coupled to the base. The shoe moves in a lateral direction along the slat to move an item across the slat. The bumper deflects when a threshold force is applied indicative of a jam to allow the item to slide over the base. A drive system is configured to move the slat in a longitudinal direction. The slat includes slat pins. A slat coupler couples the slat to the drive system. The slat coupler includes a carriage base, a coupler arm, and a retainer clip. The carriage base with pin notches is coupled to the drive system. The coupler arm with pin notches is pivotally coupled to the carriage base. The coupler arm is closed against the carriage base with the slat pins disposed within the pin notches. The retainer clip is clipped to the slat pins. The retainer clip contacts the coupler arm to retain the coupler arm in a closed position where the coupler arm is closed against the carriage base.

### BACKGROUND

Sortation systems or sorters are commonly mechanical systems that separate and/organize items such as luggage, mail, packages, and the like. One common type of sortation systems are conveyor-based systems that are for example designed to divert packages or other items onto individual diversion conveyor lanes and/or chutes. One typical conveyor-based sortation system is a shoe-based sortation system which can also be referred to as a shoe sorter. A shoe sorter is a conveyor-based sortation system that includes conveyor slats on which pushers or shoes are slidably attached. The shoes slide in a side-to-side motion relative to the bed formed by the slats so as to divert packages as well as other items to designated diverter lanes or chutes. During operation, a package can become jammed in a lane, and as the shoe attempts to divert additional packages along the same lane by sliding laterally along the slat, the shoe and/or the packages can become damaged. The resulting damage may require repair to the sortation system which in turn results in undesirable downtime. Once damaged, it can be difficult to replace the shoes and/or slats which in turn can further reduce the uptime of the sortation system. Thus, there is a need for improvement in this field.

### SUMMARY

To address the above-mentioned as well as other issues, a unique shoe design for a shoe sorter has been developed. The shoe includes a base with angled surfaces or sloped sides that allow packages to ride over the shoe when a jam occurs. The shoe further includes one or more bumpers that are configured to deflect to allow the product or other items to pass over the shoe without damage to the shoe or the rest of the sortation system when a jam or other issue occurs. In one form, the base is in the form of a rigid structure, such as a hard plastic, and the bumpers are made of a flexible material, such as elastomeric material, that allow the bumper to bend or deflect when a jam occurs. In the event of a jam or higher than normal diverting force for any reason, the bumper in one example flexes or folds out of the way, such that the product can pass over the shoe without damage to the shoe and/or diverter mechanism. In one form the shoe further includes cavities that are configured to receive at least a portion of the bumper as the bumper flexes or folds out of the way during a jam. In other variations, the bumper does not fold away flush to the shoe base, but instead, the bumper just moves enough so the package or other item can be forced over the bumper. Typically, sorters require ramped guide rails on spurs that allow a package to exit the sorter entirely in the case the package is misaligned with the spur entrance. As will be recognized, this design reduces the risk of a sorter crash or damage to the slat and/or shoe when a package jam occurs. The unique shoe provides a more forgiving design for the guide rails on spurs because if a product or package hits or catches a guide rail, the shoe will release the package before significant damage occurs.

In one example the shoe has a single bumper such that the shoe is able to divert packages only to one side. In another example, the shoe is a double-sided shoe that includes at least two bumpers for diverting packages in either lateral direction. By having a double-sided shoe design, the number of inventory parts is reduced and the overall cost of the shoe is reduced. This double-sided shoe design also facilitates closer package spacing without the risk of damage of the packages being accidentally spaced too closely and hitting already diverted shoes. Other designs again can incorporate different shoes for single-sided sorters to allow product to freely pass over the back of the shoe in case the diverting package catches on a neighboring shoe that is already diverted. In one variation, the shoes extend in a diverging manner and at an acute angle relative to one another on opposing sides of the shoe. This diverging orientation along with the angled shape of the base of the shoe allows the shoe to angle the packages or other items in the general direction of the diversion lane or chute when diverting the package.

Various actuation or diverter mechanisms can be used to move the shoe. In one particular example, a follower bearing arrangement is used to slide the shoe on the slat. Of course, other types of diverter mechanisms for the shoe can be used. In another example, instead of an elastomeric bumper, the bumper includes a rigid piece that is pivotally connected to the base through a spring and/or elastomeric element. For instance a hinge and a biasing spring type attachment can be used to secure the bumper to the base of the shoe. As a product overcomes the spring force, the bumpers are able to pivot out of the way so as to allow the package or other products to ride over the shoe during a jam. In another example, a floating spring design such as a metallic and/or elastomeric spring element secures the bumper to the base so as to facilitate the foldaway capability of the bumper when the force exceeds the spring level of the spring.

In another variation, only the bumpers are designed to be positioned above the conveying surface or bed, which is formed by the slats, so as to allow only the bumpers to engage and divert packages. In other variations, a portion of the base of the shoe can be used to achieve the diverting action without having the bumper involved so long as the force used to divert the product is lower than what is required to damage the sorter so as to facilitate the product to ride over the shoe.

Another aspect of the sorter design concerns a feature that allows the individual slats to be readily replaced. This can be quite helpful to reduce downtime by speeding the process of replacement when a slat and/or shoe requires service. The system uses a unique clamping slat drive coupler with a retainer clip that secures the coupler in a clamped position where pins from the slat are clamped in the coupler. This clamping slat coupler can be used for instance in sorters and/or conveyors. In one form, only a simple prying tool, such as a flat head screwdriver, putty knife, butter knife, nail puller, crowbar, etc., is required to remove and reinstall the diverter slat. In one form, a series of pivotal clamping elements are used to secure the slat to a drive chain of the sorter. To remove the diverter, a spring clip is pried from a slat carriage via a flat head screwdriver or other similarly shaped tool, or even by hand. Once the clip is removed, the other clamping elements for securing the slat to the drive system are able to be released from the pins on the drive chain. A replacement slat can then be installed using the reverse operation.

It should be recognized that selected features can be incorporated into other systems besides sortation systems. For example, some of the features can be incorporated into conveyor systems and/or sortation systems that do not use conveyors.

Further forms, objects, features, aspects, benefits, advantages, and embodiments of the present invention will become apparent from a detailed description and drawings provided herewith.

### BRIEF DESCRIPTION OF THE DRAWINGS

FIG. 1 shows a partial perspective view of a sortation system with some of the diverter slats removed.

FIG. 2 shows a top view of the FIG. 1 sortation system.

FIG. 3 shows an enlarged top view of the FIG. 1 sortation system as an item is diverted.

FIG. 4 shows a top perspective view of a diverter slat assembly used in the FIG. 1 sortation system.

FIG. 5 shows a top view of the FIG. 4 diverter slat assembly with a shoe removed.

FIG. 6 shows a bottom perspective view of the FIG. 4 diverter slat assembly.

FIG. 7 shows a bottom view of the FIG. 4 diverter slat assembly.

FIG. 8 shows a top, front perspective view of a unique shoe used in the FIG. 4 diverter slat assembly.

FIG. 9 shows a rear top perspective view of the FIG. 8 shoe.

FIG. 10 shows a top view of the FIG. 8 shoe.

FIG. 11 shows a bottom view of the FIG. 8 shoe.

FIG. 12 shows a front view of the FIG. 8 shoe.

FIG. 13 shows a rear view of the FIG. 8 shoe.

FIG. 14 shows a side view of the FIG. 8 shoe.

FIG. 15 shows a cross-sectional view of the FIG. 8 shoe as taken along line 15-15 in FIG. 14.

FIG. 16 shows a top, enlarged view of the sortation system of FIG. 1 as items ride over the shoes, such as during a jam.

FIG. 17 shows an enlarged top view of the shoe engaged with a drive chain of the FIG. 1 sortation system.

FIG. 18 shows a bottom perspective view of the coupling between the drive chain and the FIG. 4 diverter slat assembly of the FIG. 1 sortation system.

FIG. 19 shows an exploded view of a coupling system used to couple a diverter slat to a drive or slat carriage in the FIG. 1 sortation system.

FIG. 20 shows a front perspective view of a carriage base found in the FIG. 19 coupling.

FIG. 21 shows a rear perspective view of the FIG. 20 carriage base.

FIG. 22 shows a top perspective view of a coupler arm or clamping element found in the FIG. 19 coupling.

FIG. 23 shows a bottom perspective view of the FIG. 22 coupler arm.

FIG. 24 shows a rear view of the FIG. 22 coupler arm.

FIG. 25 shows a rear perspective view of a retainer clip or clip element found in the FIG. 19 coupling.

FIG. 26 shows a front view of FIG. 25 clip.

FIG. 27 shows an enlarged view of a coupling between the FIG. 20 carriage support structure and the FIG. 22 clamping element.

FIG. 28 shows an enlarged perspective view of the FIG. 4 diverter slat assembly during slat replacement.

FIG. 29 shows an enlarged perspective view of the FIG. 4 diverter slat assembly during securing of the slat with the FIG. 22 coupler arm.

FIG. 30 shows an enlarged perspective view of the FIG. 4 diverter slat assembly during clipping of the FIG. 25 clip.

FIG. 31 shows an enlarged side view of the FIG. 4 diverter slat assembly once assembled.

FIG. 32 shows a cross-sectional view of another example of a shoe that is used in the FIG. 1 system.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

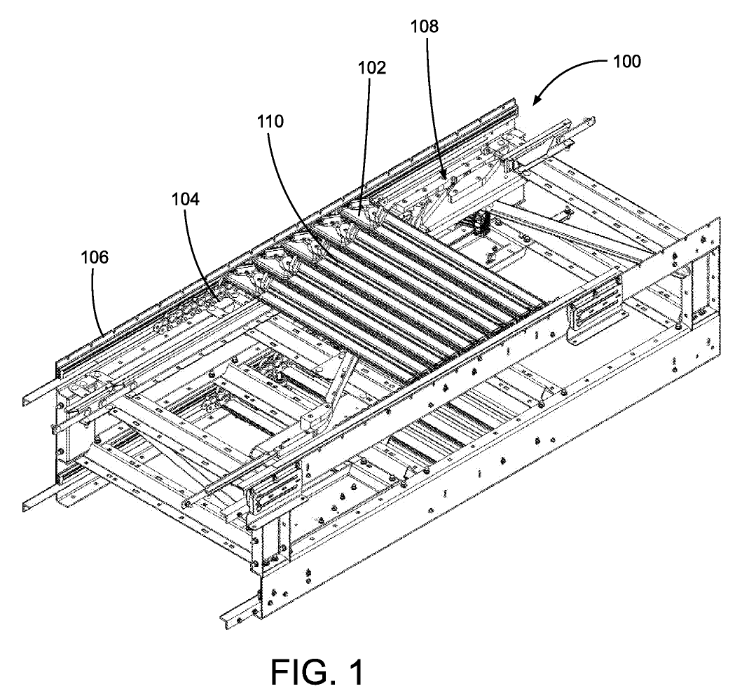

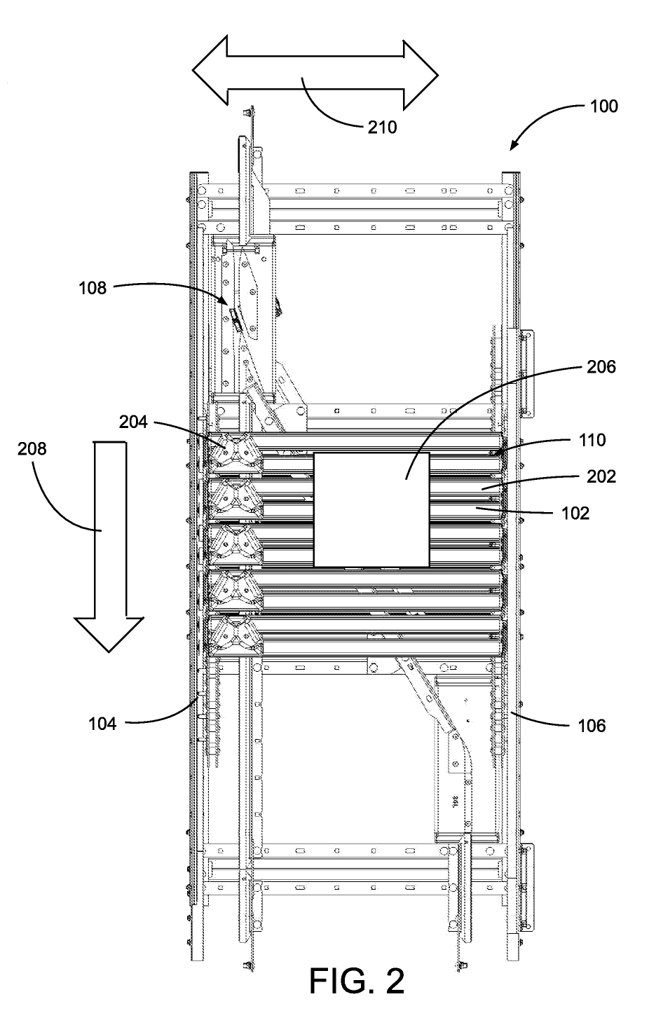

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

A perspective view of a section of a sortation system or sorter 100 with selected components removed for clarity is depicted in FIG. 1. As shown, the sorter 100 includes one or more diverter slat units or assemblies 102 that are operatively connected to a drive system 104 which moves the diverter slat units 102 along a conveyor frame 106. The system 100 further includes a diverter switch or actuation system 108 that controls the diverter action of the sorter 100. In the depicted example, the diverter slat units 102 are arranged in a side-by-side fashion so as to form a support bed 110. In the illustrated example, the drive system 104 utilizes a drive train type configuration in which a drive chain is driven by a motor to recirculate the diverter slat units 102. Of course, in other examples, different types of other types drive systems can be used and the diverter slat units can be recirculated in other directions and/or manners.

Looking at FIG. 2, each diverter slat unit 102 includes one or more slats 202 and diverter shoes 204 that are slidably coupled to the slats 202. As shown, an item 206, such as a package or box, is carried on the support bed 110 formed by the series of diverter slat units 102. The drive system 104 moves the item 206 by moving the diverter slat units 102 in a longitudinal direction 208 relative to the frame 106 of the sorter 100. As depicted by double arrow 210, the shoes 204 are configured to move the item 206 in a lateral or side-to-side direction of the sorter. While the item 206 in the illustrated example is depicted as a box, it should be recognized that other types of items 206, such as bags, envelopes, packages, containers, bottles, and/or barrels (to name just a few examples), can be sorted with the sorter 100.

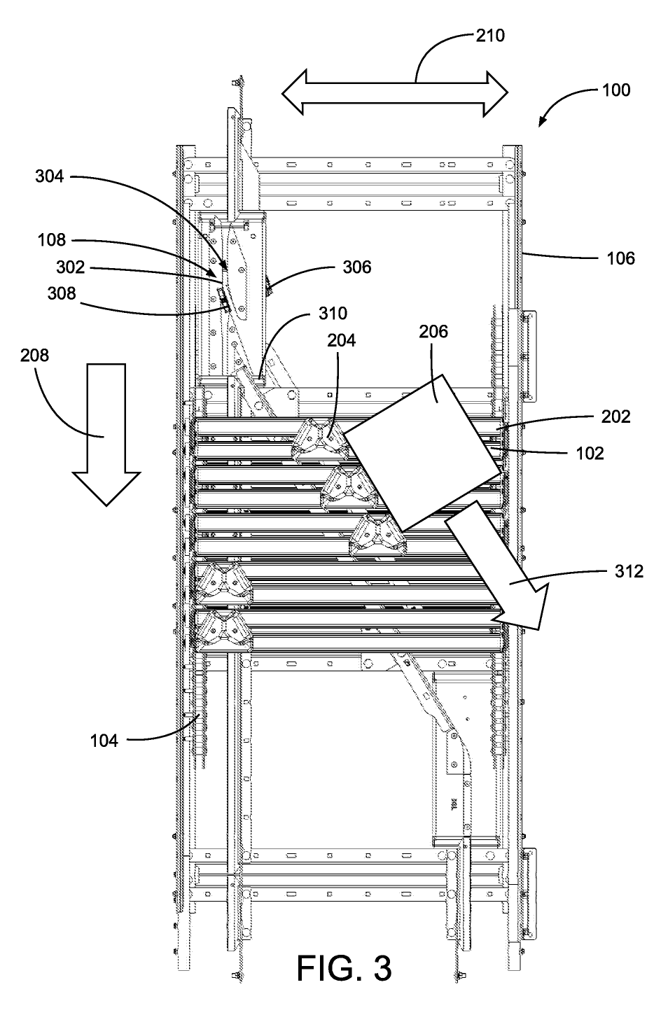

Referring to FIG. 3, the diverter actuation system 108 includes a guide member 302 that defines a guide channel 304 that is configured to guide the shoes 204. The diverter actuation system 108 includes a guide motor 306 that is configured to actuate a diverter plate 308 that when actuated diverts the shoes 204 along a diverter rail 310. When the shoes 204 are diverted along the diverter rail 310, one or more of the shoe(s) 204 push on the item 206 such that the combined longitudinal 208 and lateral 210 movement causes the item 206 to move in a diagonal direction 312 to a destination diverter lane, channel, and/or chute.

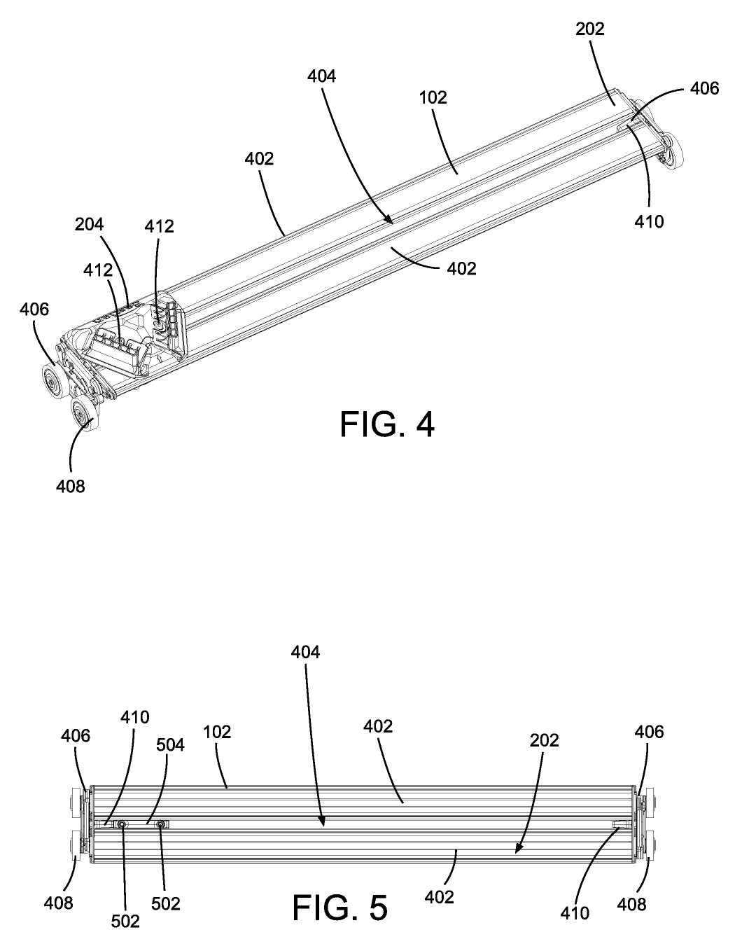

Selected features of the diverter slat unit 102 will now be described with reference to FIGS. 4, 5, 6, and 7. Looking at FIG. 4, the slat 202 in the illustrated example is formed by two or more slat members 402 that define a shoe guide slot 404 there between. The guide slot 404 helps facilitate the lateral movement of the shoe 204 during diversion. In other examples, the slat 202 can include a single slat member 402 that defines the guide slot 404 (or not). Moreover, it should be recognized that the shoe 204 can be guided via other types of guiding structures in other examples. In one form, the slat members 402 are made of aluminum, but the slat members 402 in other examples can be made of different materials, such as plastics and/or composite materials. By being made of aluminum, the slats 202 provide a smooth surface upon which the shoe 204 is able to slide. At opposite lateral ends of the unit 102, the diverter unit 102 includes a carriage 406 with wheels 408 that guide the unit 102 along the frame 106. As will be explained in greater detail below, the slat member 402 is configured to readily be coupled or decoupled from the carriage 406 so as to facilitate servicing. Proximal to the carriages 406 at each end of the guide slot 404, the slats 202 have a buffer member or stop 410 that limits the lateral travel of the shoe 204.

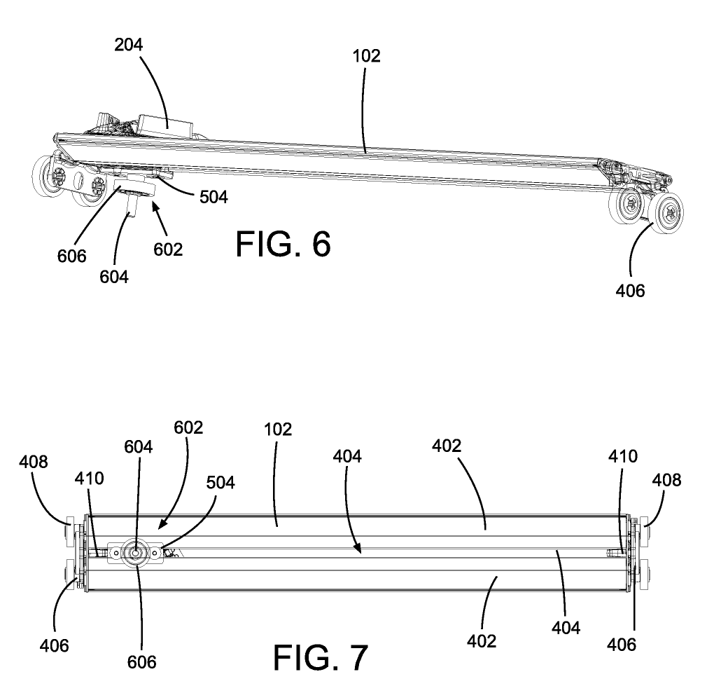

Turning to FIGS. 4 and 5, the shoe 204 is secured via one or more fasteners 412, which are in the form of bolts in the illustrated example, to fastener openings 502 in a shoe guide 504 that is slidably disposed in the shoe guide slot 404. FIG. 5 shows a top view of the diverter slat unit 102 with the shoe 204 removed. Referring to FIGS. 6 and 7, the shoe guide 504 includes a diverter guide member or follower 602 that is configured to engage the guide channel 304 and diverter rail 310 so as to guide the movement of the shoe 204 relative to the slat unit 102. As depicted, the guide member 602 includes a guide pin 604 configured to extend in the guide channel 304, and a guide wheel 606 is rotatably disposed around the guide pin 604 so as to facilitate smooth movement and guidance of the shoe guide 504.

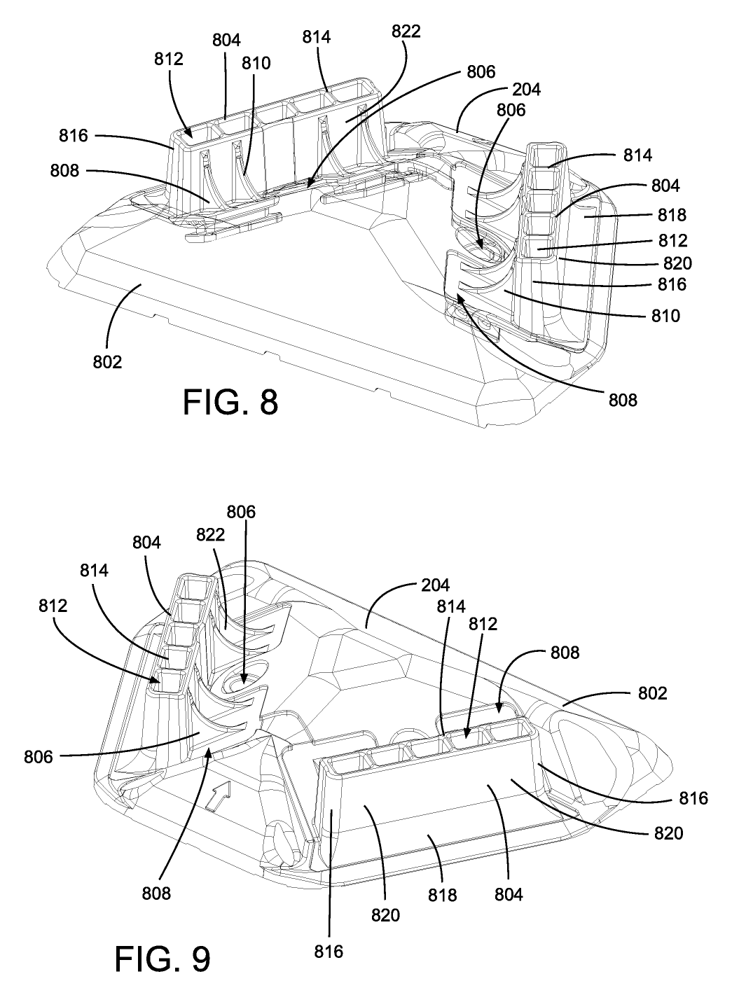

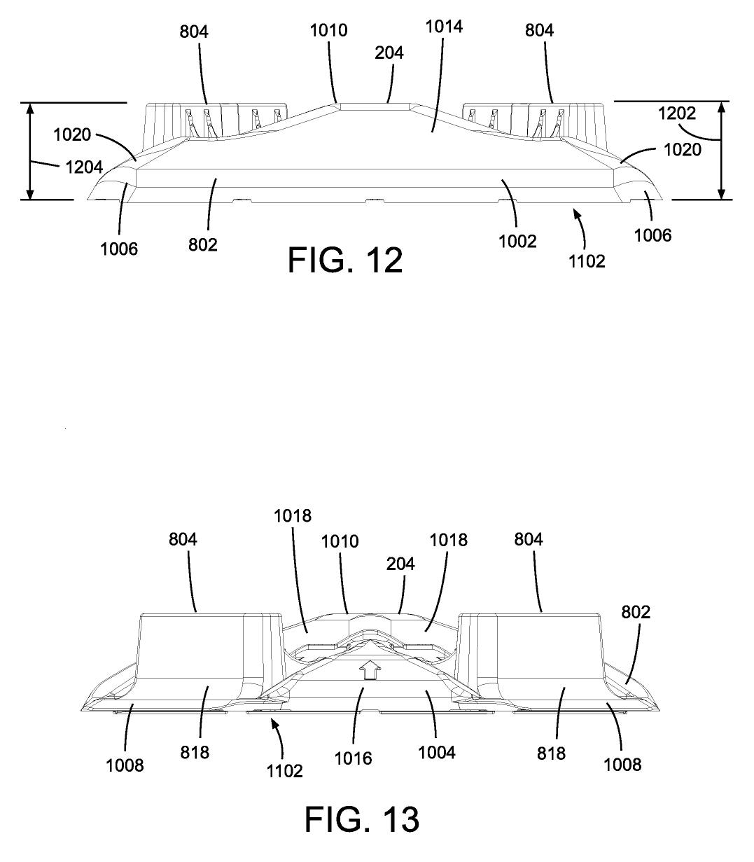

As explained before, the shoe 204 is designed to divert items 206 in a lateral 210 or diagonal 312 direction and is further designed to have a profile that minimizes damage when any type of jamming or other event occurs. In particular, the item 206 is able to ride over the shoe 204 when the particular item such as a package is stuck. The specific structure and other physical features of the shoe 204 will now be described with reference to FIGS. 8, 9, 10, 11, 12, and 13, at least initially. As shown, the shoe 204 includes a base 802 and one or more bumpers 804 extending from the base 802. Once installed, the bumpers 804 generally extend transverse or perpendicular to the slat 202 while the base has angled and/or curved surfaces that generally extend at a smaller acute angle relative to the slat 202. The base 802 defines one or more fastener openings 806 configured to receive the fasteners 412 that secure the shoe 204 to the shoe guide 504. In the illustrated example, the shoe 204 includes two bumpers situated on generally opposing sides of the shoe to facilitate sortation in either lateral direction 210, but in other examples, the shoe 204 can include a single bumper 804 for diverting items 206 in a single lateral direction 210. In other examples, the shoe 204 can include more than two bumpers 804. For instance, the shoe 204 can include at least two bumpers 804 on each side. The bumpers 804 are designed to provide sufficient force to push or otherwise divert the items 206 on the sorter 100, but at the same time, the bumpers 804 are flexible enough so as to deform or flex when a threshold force between the shoe 204 and the item 206 is created which is indicative of the item 206 being jammed or other types of malfunctions. Once flexed, the bumpers 804 allow the item 206 to ride over the shoe 204 as the shoe 204 moves in the lateral direction 210 on the diverter unit 102. In one form, the base 802 is made of a hard plastic material, and the bumpers 804 are made of a softer or elastomeric material that allows flexing of the bumpers 804. In one particular example, the bumpers 804 are made of a flexible urethane material that is over molded onto the base 802 which is made of a hard or rigid plastic material. Inboard of the bumpers 804, the base 802 defines one or more bumper cavities 808 that are configured to facilitate deflection of the bumpers 804. In one form, the bumper cavities 808 are configured to receive at least part of the bumpers 804 when folded. In other examples, the bumper cavity 808 is configured to receive the entire bumper when folded such that the bumper 804 is a flush with the base 802.

As depicted, each bumper 804 has one or more support ribs 810 received in the bumper cavity 808. The support ribs 810 are designed to flex or crumple when a sufficient force is applied to the bumper 804. To further reduce weight as well as promote the pliability of the bumper 804, the bumpers 804 have crumple cavities 812 that are separated by one or more divider walls or firewalls 814. As depicted the support ribs 810 and the divider walls 814 are arranged in an alternating fashion such that the support ribs 810 are positioned between adjacent divider walls 814. This configuration allows the support ribs 810 to crumple within the crumple cavities 812 so as to further facilitate flexing of the bumper 804 during a significant impact. To further prevent catching, the bumpers 804 have curved lateral edges 816. Opposite the support ribs 810, the bumpers 804 have a curved transition ledge 818 that faces the item 206 during engagement. From the curved transition ledge 818, the bumper 804 has a contact surface 820 that contacts the item 206 when the shoe 204 diverts the item. In the depicted example, the contact surface 820 is generally flat and extends generally perpendicular to the support bed 110 or slat 202. Opposite the contact surface 820, the bumper 804 has a deflection surface 822 to which the support ribs 810 are attached. Of note, the fastener openings 806 are located inbound of the bumpers 804 relative to the periphery of the shoe 204 (i.e., on a side facing the deflection surface 822 of the bumpers 804). With the fastener openings 806 located inboard, the deflection surface 822 of the bumpers 804 generally covers the fasteners 412 in the fastener openings 806 when the bumpers 804 are deflected. Covering the fasteners 412 with the bumpers 204 during a jam further reduce damage to the item 206 as well as reduces the risk of the shoe 204 being detached as a result of damage to the fasteners 412 from the jam.

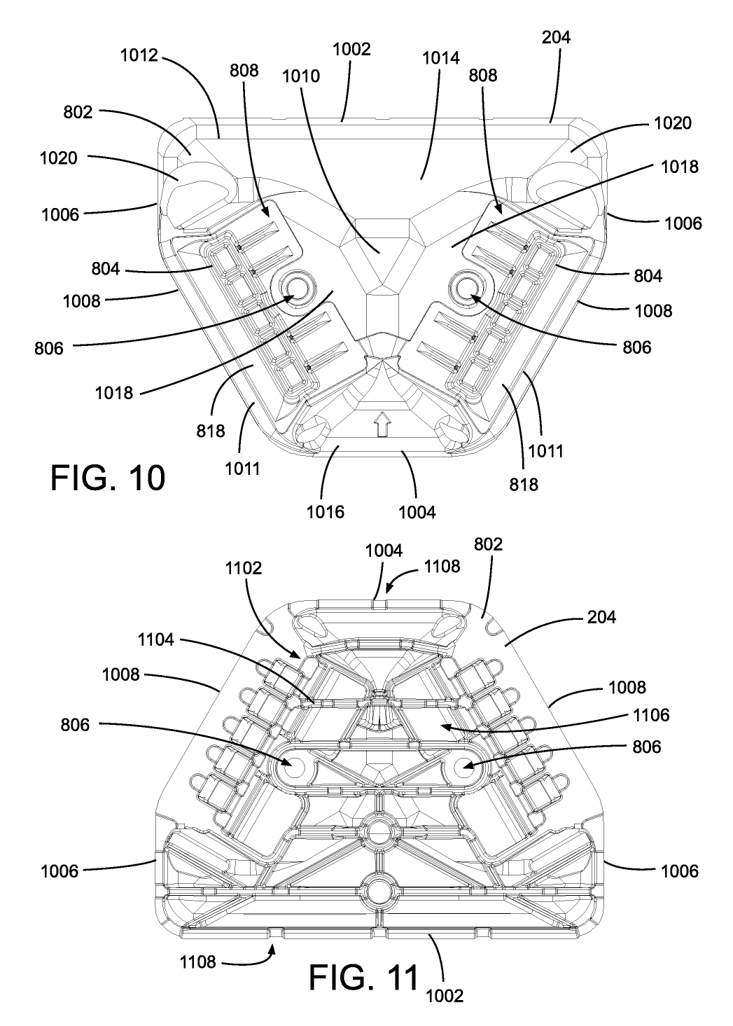

Turning to FIGS. 10 and 11, the base 802 is shaped to minimize catching and facilitate the items 206 to ride over the bumper 804. The base 802 of the shoe 204 has sloped sides that allow items 206 to slide over the shoe 204 when needed. As can be seen, the base 802 generally has a frustum type shape with a leading edge 1002 and a trailing edge 1004 that are connected together through lateral edges 1006 and bumper edges 1008. As can be seen, the leading edge 1002 is longer than the trailing edge 1004 in this example. As shown, the lateral edges 1006 extend generally transverse or perpendicular to the leading edge 1002. The bumper edges 1008 from the lateral edges 1006 taper to the trailing edge 1004 to give the bumper a frustum type profile. As can be seen, all of the edges 1002, 1004, 1006, 1008 are tapered to where they respectively engage the slat 202. In other words, the walls of the base 802 from the edges rise to form a pyramidal central bump or apex 1010. The transition between the edges are curved to further reduce catching. At the bumper edges 1008, the bumpers 804 are recessed such that any item 206 normally hits the bumper edge 1008 before engaging the bumper 804. At the bumper edge 1008, the base 802 has a ramped surface 1011 that forms an acute angle relative to the exterior surface of the slat 202. The ramped surface 1011 in one example is formed of the same hard plastic or other hard material as the rest of the base 802. By being made of harder material as compared to the bumpers 804, the ramped surface 1011 reduces the risk of the bumpers 804 wearing or otherwise being damaged by the slat 202 and/or other objects. The ramped surface 1011 forms a knife-like edge that first contacts and lifts the item 206 before the item 206 contacts the bumper 804. In the illustrated example, the base 802 has an exterior surface 1012 that forms a convex or rounded bump that allows items 206 to ride over the shoe 204.

In particular, the exterior surface 1012 is formed from a series of surfaces or facets that extends from the various edges. As can be seen, a leading surface 1014 extends from the leading edge towards the apex 1010 of the exterior surface 1012 of the shoe 204. The leading surface 1014 is angled so as to facilitate items 206 sliding over the shoe such as during jamming or other malfunctions. The leading surface 1014 is angled at an acute angle relative to the slat 202 during operation. A trailing surface 1016 extends at an acute angle from the trailing edge 1004. By having the trailing surface 1016 angled, items 206, such as boxes, are able to slide over the bumper 804 when required. Bumper surfaces 1018 extend from the bumper edges 1008 at an acute angle. As shown, the bumper cavities 808 are defined in the bumper surfaces 1018. The bumper surfaces 1018 extend at an acute angle from the bumper edge 1008 to the apex 1010 of the exterior surface 1012. Lateral surfaces 1020 extend from the lateral edge 1006 at an acute angle. As shown, the exterior surface 1012 of the shoe 204 has a general pyramidal shape and, more specifically, a tetrahedral pyramid shape. The trailing surface 1016 along with the lateral surfaces 1020 truncate the corners of the tetrahedral shape of the exterior surface 1012 of the shoe 204. As shown, the lateral surface 1020 has a generally triangular surface and rounded shape. The trailing surface 1016 likewise has a triangular surface and rounded shape. The leading surface 1014 along with the bumper surfaces 1018 are joined together at the apex 1010 to give the shoe 204 the pyramidal shape. Having the trailing surface 1016 along with the lateral surfaces 1020 angled in such a manner so as to truncate the leading surfaces 1014 and the bumper surface 1018 further promotes items 206 riding or sliding over the shoe 204 when required.

With continued reference to FIG. 11, the base 802 has a slat facing surface 1102 that engages with the slat 202. The slat facing surface 1102 is designed to reduce friction and promote smooth sliding of the shoe 204. As can be seen, the slat facing surface 1102 has a series of reinforcement ribs 1104 in the base 802 that define cavities 1106. Notches 1108 in the slat facing surface 1102 promote smooth sliding an engagement between the shoe 204 and the slat 202 as well as enhance manufacturing during the molding process.

As noted before, the leading surface 1014 is angled so as to act like a plow in order to allow the items 206 to slide over the bumper 804. The shoe 204 at the apex 1010 is truncated so as to give the exterior surface 1012 a frustum type shape. The profile or height of the base 802 as measured from the slat facing surface 1102 to the apex 1010, as indicated by double arrow 1202, is generally the same as height 1204 as measured from the slat facing surface 1102 to the edge of the bumper 804. In one embodiment, the height 1202 of the apex 1010 is at least as high as the height 1204 of the bumper 804 when the shoe 204 is assembled. In another variation, the height 1202 of the apex 1010 is generally the same as the height 1204 of the bumper 804. And still yet in other variations, the height 1202 of the apex 1010 can be slightly lower than the height 1204 of the bumper 804. With the height of the apex 1010 being at least as high as the height 1204 of the bumper along with the leading surface 1014 being angled, the item 206 is able to ride or slide over the bumper 804 without the item significantly clipping or catching on the bumpers 804. In other words, the height 1202 of the apex 1010 relative to the height 1204 of the bumper 804 allows the items 206 to readily slide over the bumper 804, such as during a jam, and prevent the item 206 from catching on the trailing edge of the bumpers 804.

Looking at FIG. 13, as was noted previously, the bumpers 804 along with the corresponding bumper edges 1008 are angled so as to promote the items 206 to travel in a diagonal orientation when being sorted or discharged. The trailing surface 1016 is again angled so as to promote the items 206 clearing the bumper 804 which in turn minimizes damage to the shoe 204 during any type of jamming or other malfunctions. During normal operation, the bumper edges along with the rest of the base 802 facilitate part of the diverting action without the bumper 804 being involved so long as the diverting force is lower than that required to damage the sorter 100 and/or shoe 204. Any excessive force over this threshold level will force the item 206 up and over the shoe 204.

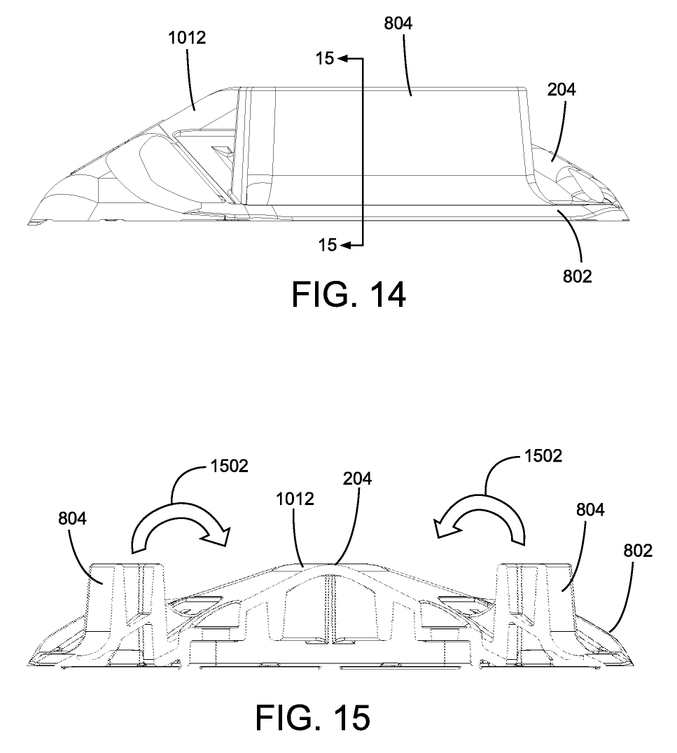

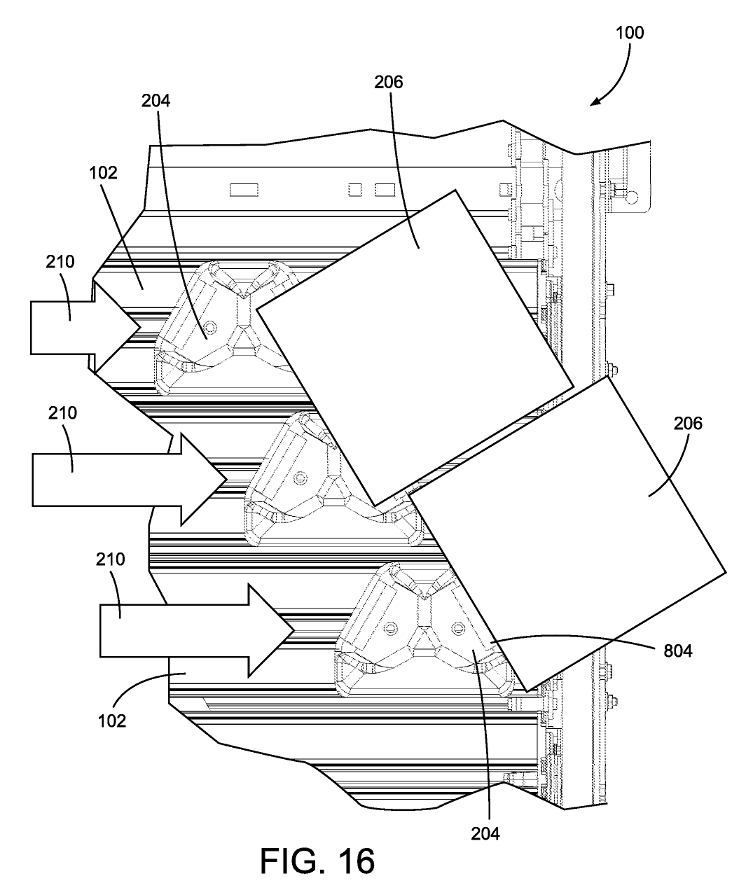

The function of the bumpers 804 will now be described with reference to FIGS. 14, 15, and 16. FIG. 15 shows a cross-sectional view of the shoe 204 as taken along line 15-15 in FIG. 14. To divert an item 206, the shoes 204 are actuated in the manner as depicted in FIG. 3. As noted before, the bumpers 804 are positioned at an angle so as to angle the item 206 in the diagonal direction 312 during sortation. When a jam occurs, such as depicted in FIG. 16, the bumpers 804 bend in the manner as indicated by arrows 1502 in FIG. 15. With the bumpers 804 bending, the items 206 are able to slide over the bumpers 204 and across the exterior surface 1012 of the shoe 204. Consequently, the shoes 204 along with the rest of the diverter slat unit 102 are generally unharmed during any type of jamming or other malfunctions.

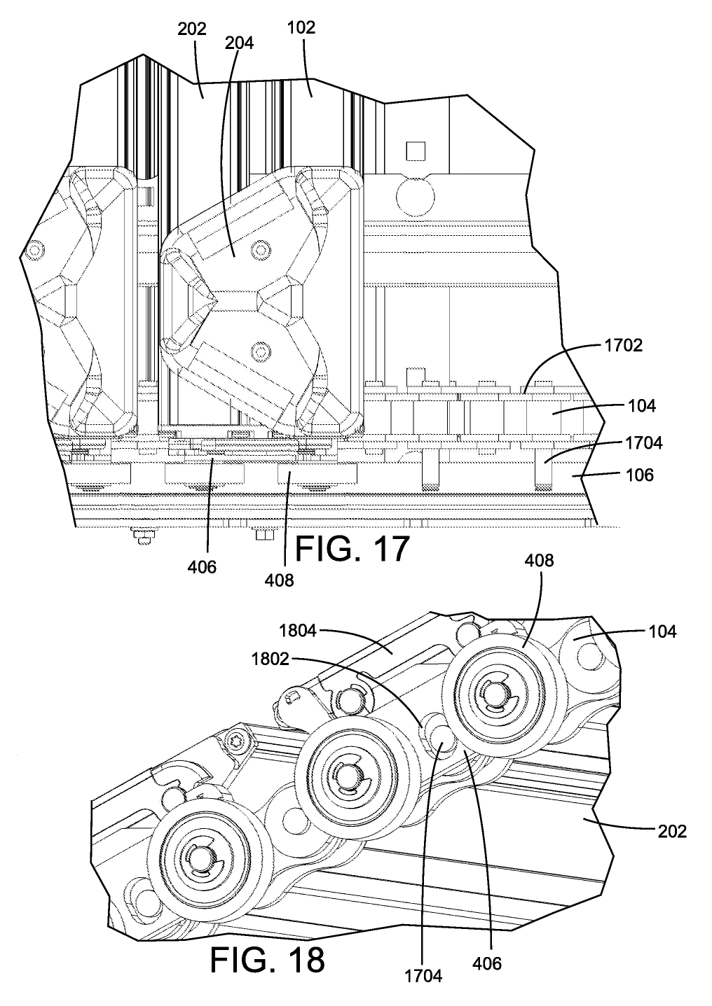

As noted before, the carriage 406 of the diverter slat unit 102 incorporates a unique quick change system that allows the slat unit 102 to be readily removed and replaced. Turning to FIG. 17, the drive system 104 in the illustrated example includes a drive link 1702 in the form of a drive chain that is driven by a motor, such as an electric and/or pneumatic motor. It should be recognized that in other examples, other types of drive systems can be used to drive the diverter slat units 102 beside the illustrated one, such as through electromagnetic (EM) propulsion. For the purposes of the discussion, the drive link 1702 will be described with reference to a drive chain, but it should be recognized that other types of drive links 1702 can be used. For example, the drive link 1702 can include a drive belt, drive rope, drive cable, and the like. In the illustrated example, the drive chain 1702 includes one or more drive coupler members or pins (pegs) 1704 that are used to secure the drive chain 1702 to the slat unit 102.

Looking at FIG. 18, the carriage 406 of the slat unit 102 defines a drive pin opening 1802 in which the drive pin 1704 is received. As can be seen, the drive pin opening 1802 has an oblong shape so as to allow the drive pin 1704 to slide within the drive pin opening 1802 so as to compensate for fluctuations in the relative position such as when the drive chain 1702 is recirculated underneath the sorter 100. The carriage 406 further includes a slat coupler 1804 that couples the slat 202 to the carriage 406.

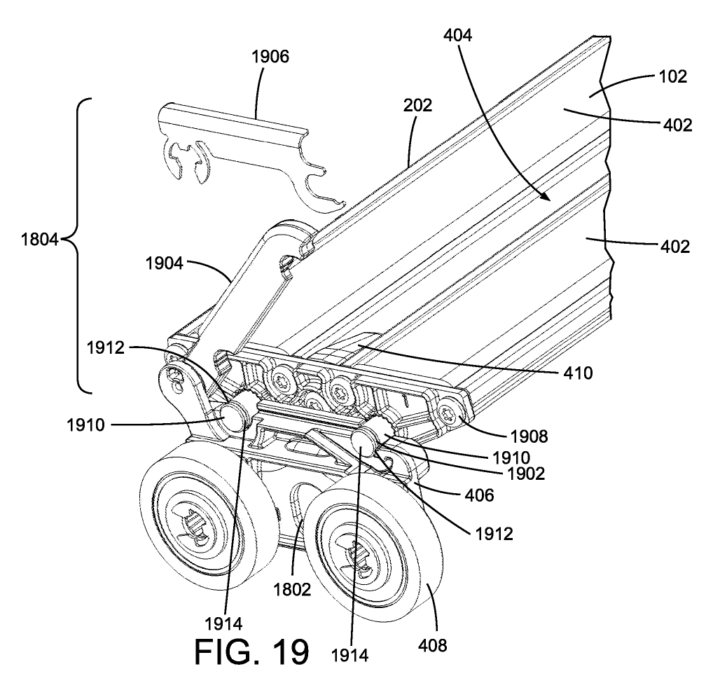

An exploded view of the slat coupler 1804 of the of the slat unit 102 is depicted in FIG. 19. As shown, the slat coupler 1804 of the carriage 406 includes a carriage base 1902, a coupler arm 1904 pivotally connected to the carriage base 1902, and a coupler retainer clip 1906 that secures or clips the coupler arm 1904 in place. As depicted, the slat 202 includes a slat bracket 1908 secured at opposite ends of the slat members 402 so as to secure the slat members 402 together as well as space the slat members 402 apart so as to create the shoe guide slot 404. Furthermore, the buffer member 410 is secured to the slat bracket 1908 in the guide slot 404. In the illustrated example, the slat members 402 and the buffer member 410 are secured to the slat bracket 1908 via fasteners, such as bolts, but in other examples, the slat bracket 1908 can be secured to the slat members 402 and buffer member 410 in other ways, such as through adhesives, welding, etc. The slat 202 has one or more slat pins 1910 extending from the slat bracket 1908 so as to be clamped between the carriage 406 and the coupler arm 1904. In the depicted example, the slat 202 includes two (2) slat pins 1910, but in other examples, the slat 202 can include more or less than is shown. In the illustrated example, the slat pins 1910 are incorporated in the slat members 402 and extend through the slat bracket 1908. In other examples, the slat pins 1910 are incorporated as part of the slat bracket 1908. Moreover, the slat pins 1910 can be shaped differently than the cylindrical shape illustrated in the drawings. At the end opposite the slat bracket 1908, the slat pins 1910 can have one or more clip grooves 1912 defined between alternating clip ridges 1914. The retainer clip 1906, as will be explained below, engages with the clip grooves 1912 and clip ridges 1914 of the slat pins 1910 to secure the coupler arm 1904 into engagement with the slat pins 1910. In another variation, the slat coupler 1804 does not include the retainer clip 1906, but instead, the carriage base 1902 and the coupler arm 1904 have a releasable coupling structure, such as a snap-fit connector or clip, that secures the coupler arm 1904 in the closed position against the carriage base 1902. Alternatively or additionally, the retainer clip 1906 can be used to primarily retain the slat 202 and coupler arm 1904 in the lateral direction, and the coupling structure, like the snap-fit connector or clip, on the carriage base 1902 and coupler arm 1904 can be used to hold the coupler arm 1904 vertically in the closed position.

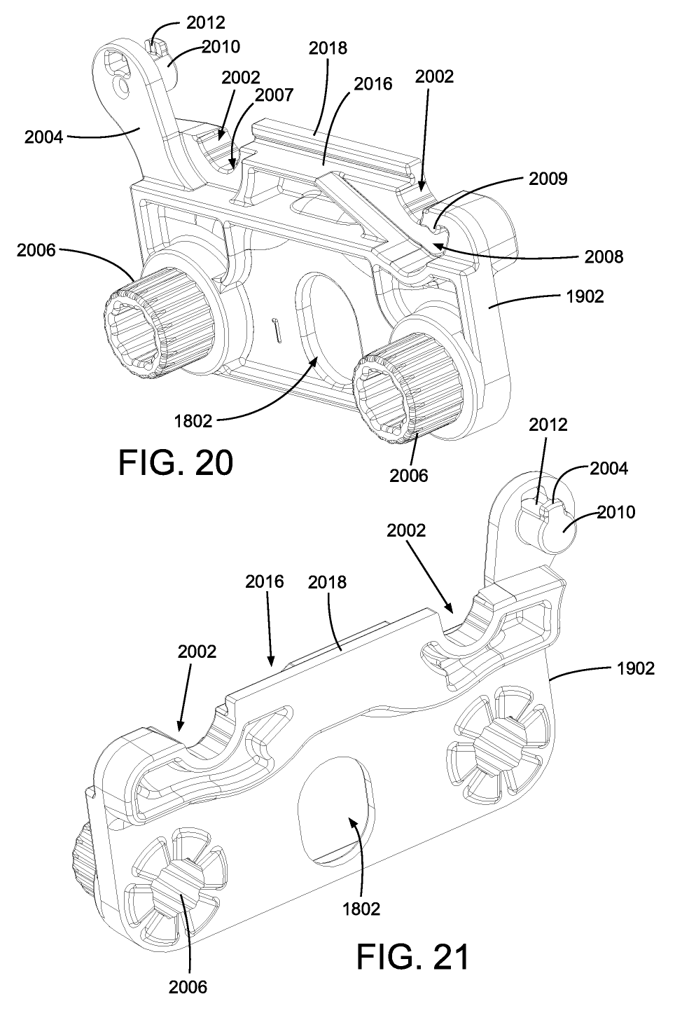

FIGS. 20 and 21 respectively show front and rear perspective views of the carriage base 1902. As shown, along with the drive pin opening 1802, the carriage base 1904 has one or more slat pin or peg notches 2002 that are located to correspond to the location of the slat pins or pegs 1910, a hinge arm 2004 to which the coupler arm 1904 is pivotally coupled, and one or more carriage wheel axles 2006 to which the wheels 408 are rotatably secured. In the illustrated example, the carriage base 1902 includes two (2) slat pin notches 2002, but this number can vary depending on the number of slat pins on the slat 202. Moreover, in some variations, the carriage base 1902 does not include any slat pin notches 2002. The location, shape, and/or other structural features of the slat pin notches 2002 can be different in other examples depending on the location, shape, and number of slat pins 1910 in the slats 202 of other designs.

Opposite the hinge arm 2004, the carriage base 1902 has a clip notch 2007 and a hook groove 2008 proximal to corresponding slat pin notches 2002 so as to respectively receive a clip and hooked end of the retainer clip 1906. As will be explained in further detail below, the coupler arm 1904 and the retainer clip 1906 are pivotally connected at opposite ends of the carriage base 1902 so as to ensure a more secure connection between the carriage 406 and the slat 202. To put it another way, with the coupler arm 1904 and the retainer clip 1906 pivotally coupled at opposite ends, it makes it difficult to accidentally remove or disengage the slat coupler 1804. The clip notch 2007 and the hook groove 2008 are shaped to protect and further limit movement of the retainer clip 1906 so as to reduce the risk of accidental release of the retainer clip 1906, such as due to a jam and/or operational vibration. In the illustrated example, the hook groove 2008 generally has a hook shape to correspond to that of the retainer clip 1906.

The hook groove 2008 has a clip retention tab or detent 2009 that is configured to retain the retainer clip 1906 in position when secured to the slat pins 1910. As shown, the hinge arm 2004 and the hook grooves 2008 are oriented on the same side opposite the slat 202 when the slat 202 and carriage 406 are coupled together so as to provide adequate space for the clip 1906.

As shown, the hinge arm 2004 includes a hinge shaft 2010 that extends generally transverse or perpendicular to the hinge arm 2004. The coupler arm 1904 is designed to pivot or rotate about the hinge shaft 2010. As can be seen, the end of the hinge shaft 2010 includes a retention tab 2012 that is configured to retain the coupler arm 1904 on the hinge shaft 2010. As will be explained in further detail below, the retention tab 2012 and the coupler arm 1904 form a type of lock and key configuration that allows the coupler arm 1904 to be coupled to and removed from the carriage base 1902 when the coupler arm 1904 is oriented at a specific position. When the coupler arm 1904 is rotated to engage the slat pins 1910, the retention tab 2012 holds the coupler arm 1904 on the hinge arm 2004. Between the slat pin notches 2002, the base 1902 has an alignment groove 2016 with an alignment rail 2018 that inhibits lateral motion of the coupler arm 1904 relative to the carriage base 1902.

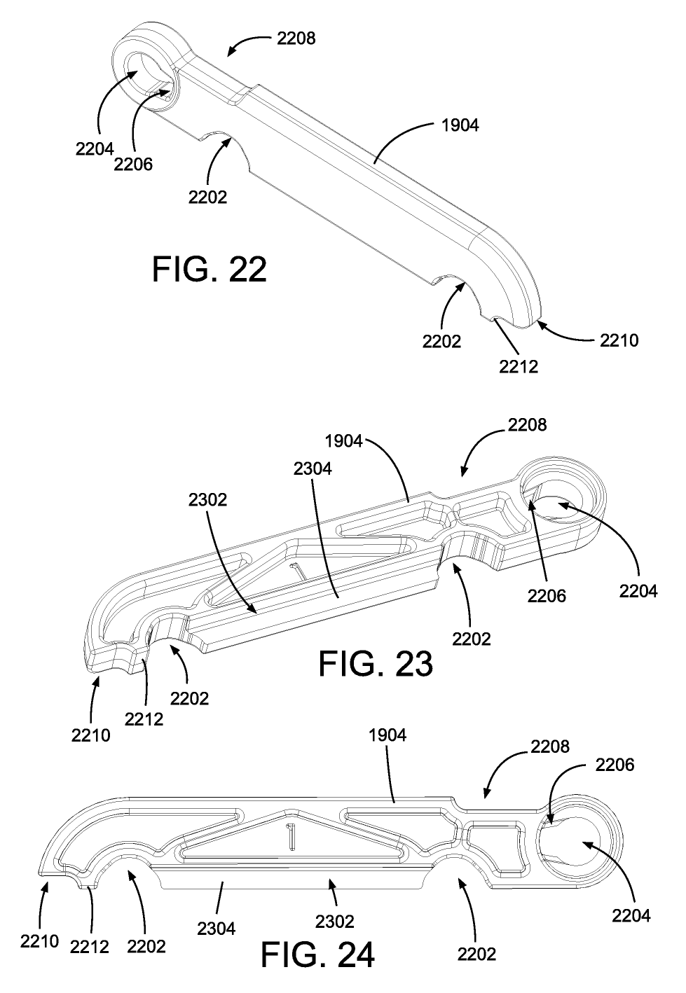

Turning to FIGS. 22, 23, and 24, the coupler arm 1904 has slat pin or peg notches 2202 that are configured to clamp to the slat pins 1910 of the slats 202. The location, shape, and/or other structural features of the slat pin notches 2202 can be different in other examples depending on the location, shape, and number of slat pins in the slats 202 of other designs. The number of slat pin notches 2202 can vary depending on the number of slat pins 1910 on the slat 202. Moreover, in some variations, the coupler arm 1904 does not include any slat pin notches 2202. In one form, the slat pins 1910 are sandwiched between the carriage base 1902 and the coupler arm 1904 without any slat pin notches 2002, 2202 on the carriage base 1902 and the coupler arm 1904. In other variations, the slat pin notches are only one of the components (i.e., the carriage base 1902 or the coupler arm 1904). The slat pin notches 2002 on the coupler arm 1904 are designed to clamp the slat pins 1910 in between the slat pin notches 2202 on the coupler arm 1904, and the slat pin notches 2002 on the carriage base 1902. The coupler arm 1904 further defines a hinge shaft opening 2204 in which the hinge shaft 2010 is received. The hinge shaft opening 2204 has a key tab notch 2206 that is shaped to receive the retention tab 2012 such that the hinge shaft 2010 can be inserted through the hinge shaft opening 2204. When the retention tab 2012 of the hinge shaft 2010 is aligned with the key tab notch 2206, the hinge shaft 2010 of the coupler arm 1904 can be inserted through the hinge shaft opening 2204. Upon rotation of the coupler arm 1904 relative to the carriage base 1902, the retention tab 2012 is able to retain the coupler arm 1904 on the hinge shaft 2010. The coupler arm 1904 further includes a tool notch 2208 proximal to the hinge shaft opening 2204. As will be explained in greater detail below, the tool notch 2208 allows a tool, such as the end of a flat head screwdriver, to be inserted between the coupler arm 1904 and the retainer clip 1906 so as to be able to pry the retainer clip 1906 from the coupler arm 1904. To put it another way, the tool notch 2208 is able to form a gap to receive a tool that is then able to pry or release the retainer clip 1906 from the coupler arm 1904. The tool notch 2208 is positioned at the end proximal to the hinge shaft opening 2204 so as to provide sufficient torque for prying the retainer clip 1906 from the coupler arm 1904. At the end opposite the hinge shaft opening 2204, the coupler arm 1904 has a clearance notch 2210 that forms a contact tab 2212 between the clearance notch 2210 and the corresponding proximal slat pin notch 2002. When the coupler arm 1904 is closed around the slat pins 1910, the clearance notch 2210 and tab 2012 forms a space or clearance to receive a tool or other implement to facilitate prying of the coupler arm 1904 from the carriage base 1902 during removal.

Turning to FIGS. 23 and 24, the coupler arm 1904 further incorporates an alignment groove 2302 with an alignment rail 2304. As shown, the alignment groove 2302 and the alignment rail 2304 extend between the slat pin notches 2202. When the coupler arm 1904 is in the closed position against the carriage base 1902, the alignment rail 2304 of the coupler arm 1904 is received in the alignment groove 2016 of the carriage base 1902 (FIG. 20), and the alignment rail 2018 of the carriage base 1902 is received in the alignment groove 2302 of the coupler arm 1904. With this engagement, lateral movement of the coupler arm 1904 relative to the carriage base 1902 is inhibited which in turn reduces the risk of the coupler arm 1904 and/or retainer clip 1906 being dislodged.

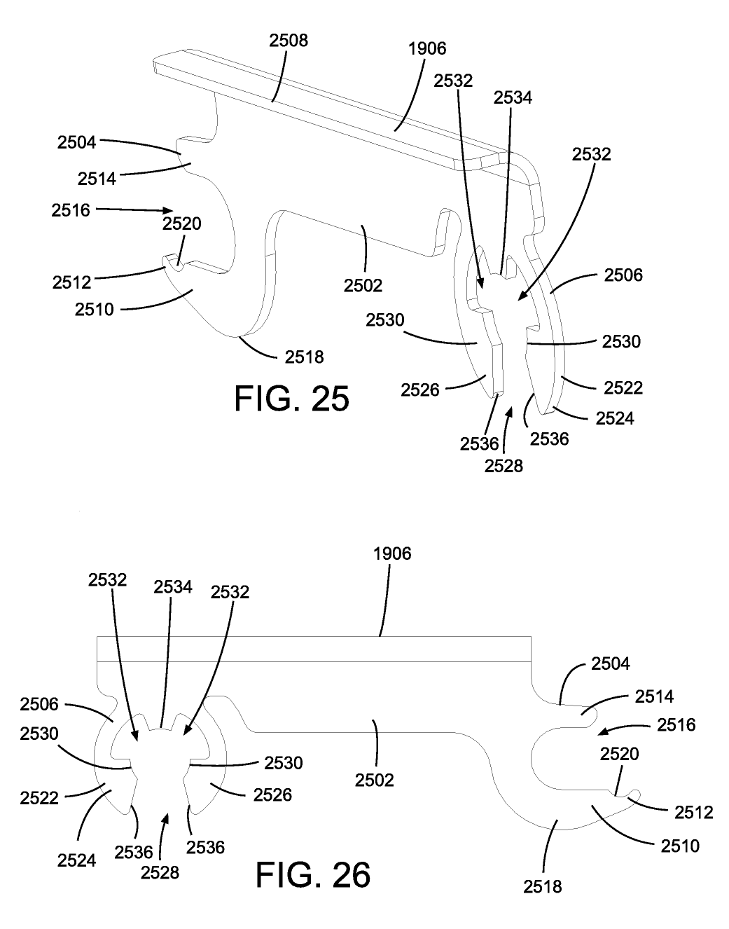

The retainer clip 1906 will now be described with reference to FIGS. 25 and 26. As depicted, the retainer clip 1906 has a clip body 2502 with a hook end 2504 and a clip end 2506 located at opposite ends of the clip body 2502. Both the hook end 2504 and the clip end 2506 are configured to engage the slat pins 1910 during attachment. A flange or rib 2508 extends along the length of the clip body 2502 in the illustrated example. As can be seen, the flange 2508 extends transverse to the clip body 2502. Among other things, the flange 2508 helps to locate the retainer clip 1906 along the coupler arm 1904 as well as provides a prying surface for removing the retainer clip 1906 from the coupler arm 1904 during removal of the slat 202. In the illustrated example, the flange 2508 extends along the entire length of the clip body 2502, but in other examples, the flange 2508 can only span along part of the clip body 2502, or could be eliminated altogether.

At the hook end 2504, the retainer clip 1906 has a pin hook 2510 that includes a hook finger 2512, a retention finger 2514, and a hook opening 2516 defined between the fingers 2512, 2514. In the illustrated example, the hook opening 2516 is generally U-shaped and opens longitudinally relative to the clip body 2502. The hook finger 2512 is longer than the retention finger 2514. To promote rotational or pivotal movement of the pin hook 2510, the hook finger 2512 has a curved exterior edge 2518 that is received in the clip groove of the carriage base 1902. Near the tip, the hook finger 2512 has a detent notch 2520 that opens facing the hook opening 2516. The detent notch 2520 is located and shaped to engage the clip retention tab 2009 in the hook groove 2008 of the carriage base 1902 when secured. The engagement between the clip retention tab 2009 and the detent notch 2520 inhibits accidental transverse motion of the retainer clip 1906. The retention force between the two can be overcome when a mechanic or other individual pries the clip 1906 from the coupler arm 1904.

At the clip end 2506, the retainer clip 1906 has a clip or snap element 2522 that is configured to snap to the slat pin 1910. The snap element 2522 includes first 2524 and second 2526 snap fingers with a snap or pin opening 2528 defined between the fingers 2524, 2526. In the depicted example, each finger 2524, 2526 has a pin engagement edge 2530 that is curved in order to engage and retain the slat pins 1910 in the set pin opening 2528. The fingers further include one or more relief notches 2532 that facilitate in making the fingers 2524, 2526 more resilient or able to bend so as to receive the pins 1910. Between the fingers 2524, 2526, the clip body 2502 has a pin engagement edge 2534 that is curved to engage the pin to 1910. As can be seen, the pin engagement edges 2530, 2534 provide three (3) points of contact for retaining the pins 1910. To retain the pin 1910 in the pin opening 2528, the curved pin engagement edges 2530 of the fingers 2524, 2526 extend so as to envelop more than 90° of the circumference of the pin 1910. At the entrance of the snap pin opening 2528 the fingers 2524, 2526 have guide edges 2536 that are beveled or chamfered so as to facilitate guiding of the slat pin 1910 into the pin opening 2528. Once the diameter of the pin 1910 passes or engages the pin engagement edges 2530, the slat pin 1910 is snapped into position within the snap pin opening 2528 so as to engage the pin engagement edges 2530, 2534, thereby being retained within the snap element 2522. As can be seen, the hook opening 2516 of the pin hook 2510 and the snap pin opening 2528 of the snap element 2522 open at a transverse or perpendicular orientation relative to one another in order to reduce the retainer clip 1906 from being accidentally dislodged from the pins 1910.

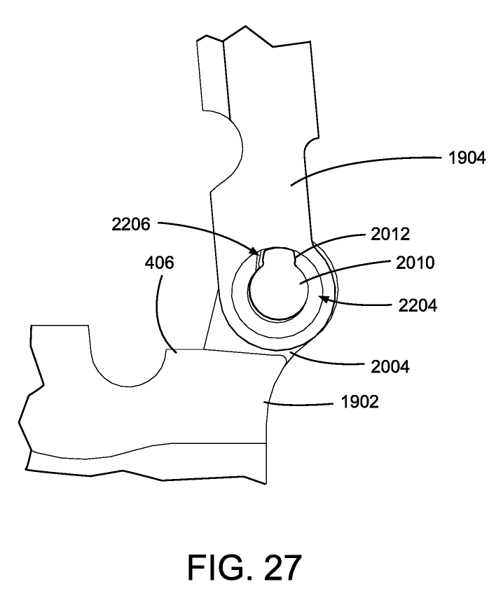

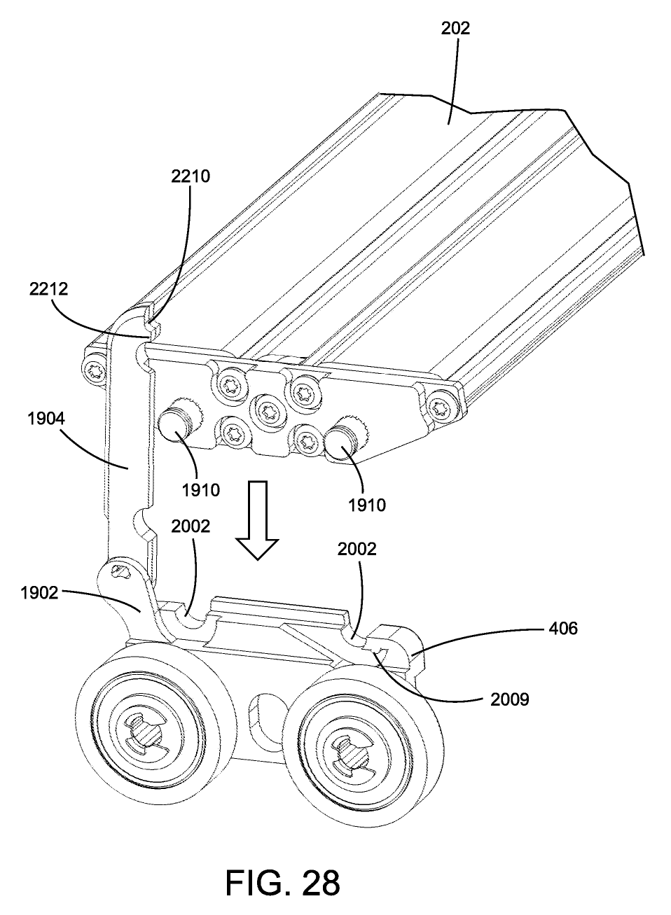

A technique for coupling and decoupling the diverter slat unit 102 from the drive chain 1702 will at least initially be described with reference to FIGS. 17-19 and 27-31. Turning to FIG. 27, the coupler arm 1904 is secured to the carriage base 1902 of the carriage 406 by aligning the retention tab 2012 of the hinge shaft 2010 with the key tab notch 2206 of the hinge shaft opening 2204. As shown, the coupler arm 1904 is generally oriented at a transverse or perpendicular angle relative to the carriage base 1902 during the coupling of the coupler arm 1904 to the carriage base 1902. Once the coupler arm 1904 is pivoted or rotated, the retention tab 2012 helps retain the coupler arm 1904 to the hinge arm 2004 of the carriage base 1902. Looking at FIGS. 17, 18, and 19, the carriage 406 is coupled to the drive chain 1702 of the drive system 104 by inserting the drive pins 1704 into the drive pin openings 1802 in the carriage 406. In FIGS. 28 and the subsequent drawings, the drive chain 1702 as well as other components of the sorter system 100 have been removed and not shown for the sake of clarity. It should be recognized that the slats 202 are coupled to the carriage 406, when the carriage 406 is coupled to the drive chain 1702. As can be seen, the pins 1910 of the slat 202 are aligned with the slat pin notches 2002 in the carriage 406 during assembly. In the illustrated example, the coupler arm 1904 is attached to the carriage base 1902 before the slat 202 is installed, but in other examples, the slat pins 1910 can be received in the slat pin notches 2002 before the coupler arm 1904 is attached to the carriage base 1902.

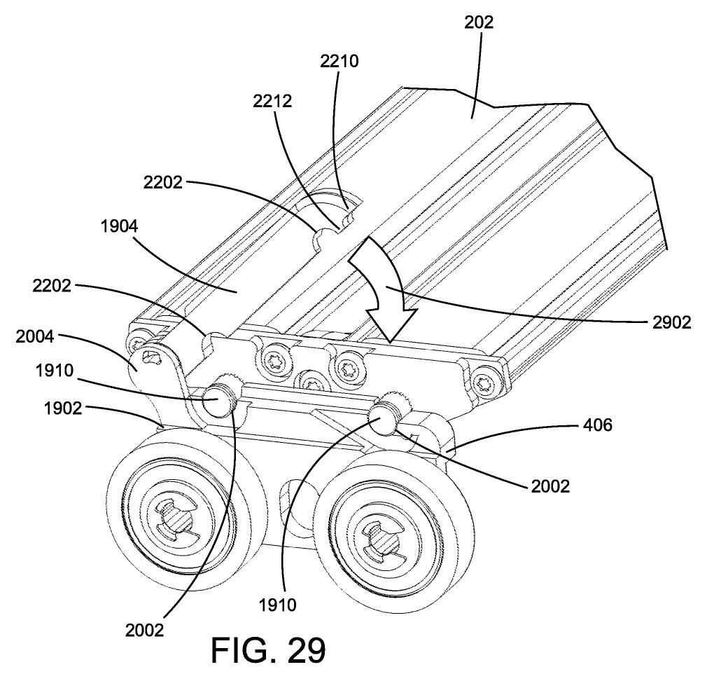

Looking at FIGS. 19 and 29, once the pins 1910 are inserted in slat pin notches 2002, the coupler arm 1904 is pivoted in the manner as indicated by the close or directional arrow 2902 in FIG. 29 such that the pins 1910 are received in the slat pin notches 2202 in the coupler arm 1904. During this closure movement, the contact tab 2212 proximal to the clearance notch 2210 contacts the carriage base 1902. Once more, the engagement of the hinge arm 2004 to the coupler arm 1904 prevents or inhibits longitudinal movement of the carriage 406 relative to the slat 202 so as to further secure the slat as the carriage moves along the sorter 100 in the longitudinal direction 208.

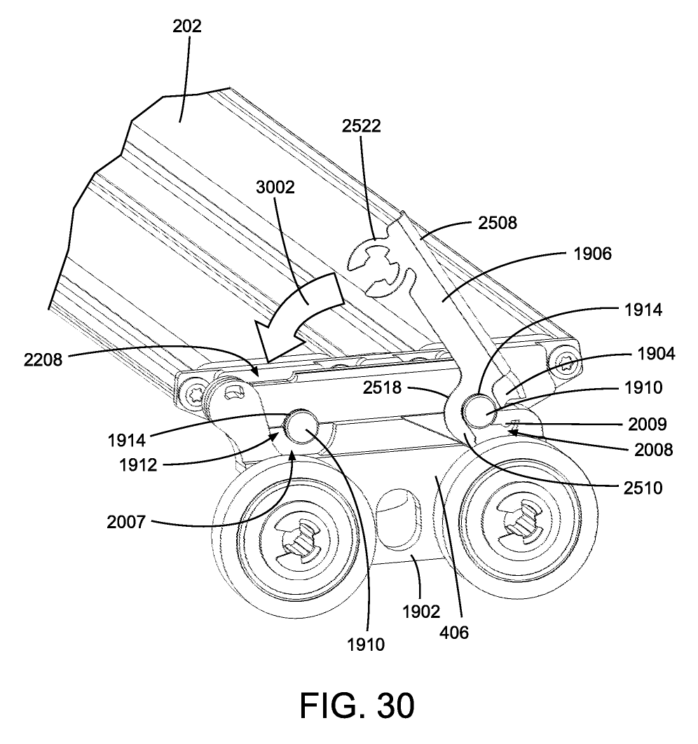

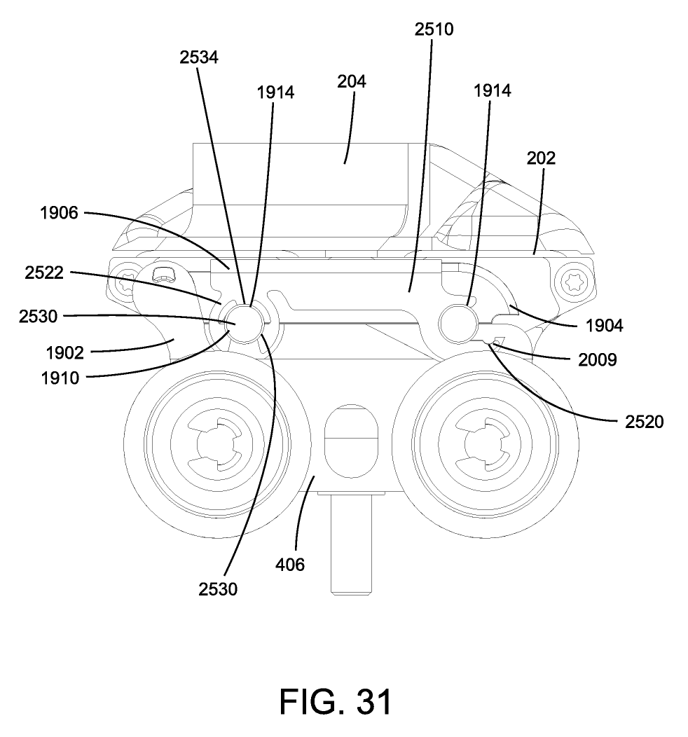

Referring to FIG. 30, the pin hook 2510 of the retainer clip 1906 is then inserted into the clip grooves 1912 between the clip ridges 1914 on the end of the slat pins 1910 proximal to the hook groove 2008 in the carriage base 1902. The effective diameter of the hook opening 2516 in the hook 2510 is generally larger than the diameter of the clip grooves 1912 and yet smaller than the outer diameter of the clip ridges 1914 so as to inhibit the clip 1906 from sliding off the pins 1910. As noted before with respect to FIG. 25, the pin hook 2510 has a curved exterior edge 2518 that facilitates rotational pivotal movement of the retainer clip 1906 relative to the pin 1910, as is indicated by indicated by arrow 3002 in FIG. 30. Looking at FIG. 31, to secure the retainer clip 1906, the snap element 2522 is clipped onto the other slat pin 1910. Referring to FIGS. 26 and 31, as the clip element 1906 is rotated in the place, the guide edges 2536 of the snap element 2522 slightly pry the fingers 2524, 2526 apart. Once the pin 1910 is received in the set pin opening 2528, the fingers 2526, 2524 resiliently spring back so as to retain the pin 1910. The pin engagement edges 2530, 2534 of the snap element 2522 are received in the clip grooves 1912 so as to inhibit lateral movement of the clip relative to the slat 202. The effective diameter of the snap opening 2528 in the snap element 2522 is generally larger than the diameter of the clip grooves 1912 and yet smaller than the outer diameter of the clip ridges 1914 so as to inhibit the clip 1906 from sliding off the pins 1910. During securing of the retainer clip 1906, the detent 2009 on the carriage base 1902 engages the detent notch 2520 on the retainer clip 1906 so as to inhibit release of the retainer clip 1906 by rotation. As noted before, the pin hook 2510 and the snap element 2522 open at transverse angles relative to one another so as to inhibit accidental release of the retainer clip 1906 when a force is applied in one or more directions. This helps to ensure a secure connection and inhibits accidental release of the slat 202 during operation. With the retainer clip 1906 clipped into place, the sorter 100 can resume operation if so desired.

A generally opposite approach is used to remove the slat 202 from the carriage 406 and drive system 104. A tool, such as a flat head screwdriver, knife, etc., is inserted in the space defined between the tool notch 2208 in the coupler arm 1904 and the flange 2508 of the retainer clip 1906 (FIG. 30). As a result, the snap element 2522 is pried from the slat pin 1910 so as to move in the opposite fashion of arrow 3002 in FIG. 30. Once fully rotated, the pin hook 2510 can be removed from the other slat pin 1910. The coupler arm 1904 can be then pivoted in the opposite fashion as depicted by arrow 2902 in FIG. 29 so as to open the coupler arm, thereby releasing the slat pins 1910 of the slat 202. The slat 202 then can be removed from the carriage 406 and replaced with a new slat 202 in the manner as described above. Alternatively or additionally, one or more of the carriages 406 can be removed from the drive chain 1702 and replaced before the new slat 202 is installed.

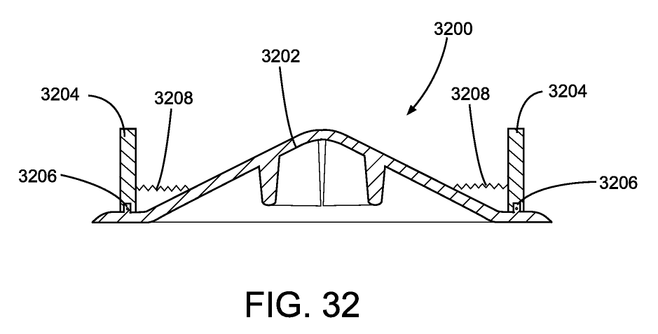

A shoe according to another example that can be used in the FIG. 1 sorter 100 will now be described with reference to FIG. 32. As shown, a shoe 3200 includes a base 3202 and one or more bumpers 3204. The base 3202 and the bumpers 3204 are generally configured in a similar manner as described above, and for the sake of brevity as well as clarity, these common features will not be described again below. For example, the base 3202 is made of a hard plastic material whereas the bumpers 3204 are made from a softer or elastic material. In other examples the bumpers 3204 may be made of a generally rigid material with or without a softer elastic material attached to their working faces. The base 3202 has a similar shape as the one first illustrated in the shoe 204 illustrated in FIG. 8. As depicted, the shoe 3200 includes at each bumper 3204 a hinge 3206 that connects the bumper 3204 to the base 3202. A spring 3208 biases the bumper 3204 into an upright position. With such a configuration, the bumper 3204 is able to pivot about the hinge 3206 when a predetermined force is applied to the bumper so as to facilitate the item 206 sliding over the exterior of the shoe 3200 such as during a jam. In one example, the hinge 3206 includes a pivot pin, but in other examples, the spring 3208 can be eliminated and the hinge 3206 can be in the form of a living hinge that is able to bend at a specific force threshold level. In one form, the spring 3208 is made out of metal, but in other examples, it can be made out of plastic material or other materials that are able to bias the bumper 3204.

### Definitions and Alternatives

The language used in the claims and specification is to only have its plain and/or ordinary meaning, except as explicitly defined below. The words in these definitions are to only have their plain and/or ordinary meaning. Such plain and/or ordinary meaning is inclusive of all consistent dictionary definitions from the most recently published Webster's dictionaries and Random House dictionaries. As used in the specification and claims, the following definitions apply to these terms and common variations thereof identified below.

“Barcode” generally refers to a visible arrangement of shapes, colors, lines, dots, or symbols fixed in some medium and arranged on the medium in a pattern configured to encode data. Examples include optical machine-readable representations of data relating to an object to which the barcode is attached such as a Universal Produce Code (UPC), or any visible patterns related to any type of Automatic Identification and Data Capture (AIDC) system. Another example of a barcode is a Quick Response Code (QR Code) which arranges various light and dark shapes to encode data. Any suitable medium is envisioned. Examples include an adhesive label, a physical page, a display device configured to display the barcode, or any other object such as a box, a machine, or other physical structure to which the barcode is affixed or upon which it is printed. For example, a bar code may be etched into metal, machined into plastic, or formed by organizing visible three-dimensional shapes into a pattern. The barcode may not be visible to humans but may be fixed using a substance or device that allows the barcode to be visible to sensors in a machine configured to read wavelengths of light outside those detectable by the human eye. Examples of this type of barcode include barcodes printed with ink that is only visible under ultraviolet (i.e. “black”) light, or barcodes displayed using infrared light.

“Bumper” generally refers to a device or structure configured to absorb some shock and/or reduce damage. In one non-limiting example, the bumper includes a flexible member, such as made from an elastomeric material, which bends when a certain threshold force is applied to the bumper. In another non-limiting example, the bumper includes a pivotal member that is biased by a spring that yields when the threshold force is applied.

“Chain” generally refers to a series of links pivotally joined together to form a medium for conveying or transmitting motion or power. In one form, the chain includes a serial assembly of connected pieces, often called links, typically made of metal and/or plastic, with an overall character similar to that of a rope in that it is flexible and curved in compression but linear, rigid, and load-bearing in tension. A chain may include two or more links.

“Container” generally refers to an object creating a partially or fully enclosed space that can be used to contain, store, and transport objects, items, and/or materials. In other words, a container can include an object that can be used to hold or transport something. By way of nonlimiting examples, containers can include boxes, totes, bags, jars, envelopes, barrels, cans, bottles, drums, and/or packages.

“Controller” generally refers to a device, using mechanical, hydraulic, pneumatic electronic techniques, and/or a microprocessor or computer, which monitors and physically alters the operating conditions of a given dynamical system. In one nonlimiting example, the controller can include an Allen Bradley brand Programmable Logic Controller (PLC). A controller may include a processor for performing calculations to process input or output. A controller may include a memory for storing values to be processed by the processor, or for storing the results of previous processing. A controller may also be configured to accept input and output from a wide array of input and output devices for receiving or sending values. Such devices include other computers, keyboards, mice, visual displays, printers, industrial equipment, and systems or machinery of all types and sizes. For example, a controller can control a network or network interface to perform various network communications upon request. The network interface may be part of the controller, or characterized as separate and remote from the controller. A controller may be a single, physical, computing device such as a desktop computer, or a laptop computer, or may be composed of multiple devices of the same type such as a group of servers operating as one device in a networked cluster, or a heterogeneous combination of different computing devices operating as one controller and linked together by a communication network. The communication network connected to the 3o controller may also be connected to a wider network such as the Internet. Thus a controller may include one or more physical processors or other computing devices or circuitry, and may also include any suitable type of memory. A controller may also be a virtual computing platform having an unknown or fluctuating number of physical processors and memories or memory devices. A controller may thus be physically located in one geographical location or physically spread across several widely scattered locations with multiple processors linked together by a communication network to operate as a single controller. Multiple controllers or computing devices may be configured to communicate with one another or with other devices over wired or wireless communication links to form a network. Network communications may pass through various controllers operating as network appliances such as switches, routers, firewalls or other network devices or interfaces before passing over other larger computer networks such as the Internet. Communications can also be passed over the network as wireless data transmissions carried over electromagnetic waves through transmission lines or free space. Such communications include using WiFi or other Wireless Local Area Network (WLAN) or a cellular transmitter/receiver to transfer data.

“Convex” generally refers to being and/or having an overall curved or rounded outward exterior like the exterior of a sphere or circle. Parts of sections of a convex shape can be flat and/or angled so as to give an overall impression of a curved or rounded shape.

“Conveyor” is used in a broad sense to generally refer to a mechanism that is used to transport something, like an item, box, container, and/or SKU. By way of nonlimiting examples, the conveyor can include belt conveyors, wire mesh conveyors, chain conveyors, electric track conveyors, roller conveyors, cross-belt conveyors, vibrating conveyors, and skate wheel conveyors, to name just a few. The conveyor all or in part can be powered or unpowered. For instance, sections of the conveyors can include gravity feed sections.

“Drive Link” generally refers to a long flexible material used to mechanically connect two or more mechanical components together. Drive links for instance may be used as a source of motion, to transmit power efficiently, and/or to track relative movement. In one example, the drive link connects a motor to a pulley and/or other type of mechanical device. Typically, but not always, the drive link can be in arranged in a loop to continuously transmit power. The drive links in one example are looped over pulleys and may have a twist between the pulleys. The overall drive link is flexible so as to facilitate bending, but individual components of the drive 3o link may be rigid. By way of non-limiting examples, the drive link can include a drive chain, a drive belt, drive rope, and/or drive cable.

“Frame” generally refers to the structure which supports the mechanical components of a conveyor and/or sorter that are configured to move items.

“Jam” generally refers to a state where one or more items, such as packages, boxes, or envelopes, have become stuck or caught on each other or on part of the sortation or conveyor equipment, and are unable to move freely downstream as a result. During a jam, the items for example can be tightly pushed together such as when one of them catches another object inside and/or outside of the sorter. In such an example, the items then may prevent components of the sorter, such as the shoes, from functioning properly. A jam may cause all or some parts of a sorter to become unable to move or work as intended due to the presence of the jammed items.

“Lateral” generally refers to being situated on, directed toward, or coming from the side.

“Linear Sortation System” or “Line Sorter” generally refer to a type of sortation system that sorts items that generally travel in a straight line. Line sorters typically, but not always, induct items at one end and move the items along the length of the sorter so as to divert the items to one or both sides of the sorter along the way, depending on the type of unit. Line sorters can for example be chain and/or belt driven, The diverting mechanisms in the line sorter can be integrated into a sortation conveyor and/or mounted to the conveyor. Non-limiting examples of line sorters include cross-belt sorters, shoe sorters, paddle sorters, pop-up transfer sorters (including line shaft pop-up wheel sorters and pop-up steerable roller sorters), pusher sorters, puller sorters, shuttle sorters, and/or tilt tray sorters, to name just a few.

“Longitudinal” generally relates to length or lengthwise dimension of an object, rather than across.

“Loop sorter”, “Loop sortation system” or “Circle Sorter” generally refer to types of sorters in which the bed of the sorter recirculates along a horizontally curved path. In one form, loop sorters are configured with beds having tight radius curves to maximize space and conform to facility limitations. Loop sorters typically, but not always, include a series of cells linked together on a track that forms a conveyor for items. Items are inducted onto these cells manually and/or automatically at one or more places or lanes along the sorter. In some non-limiting examples, the items can be automatically identified by barcode scanning, RFID scanning, and/or other identification techniques as the items travel along the sorter so as to associate the 3o identified items with a particular induction or diversion stations or lanes. For instance, once the cell and associated items arrive at a divert lane, a divert mechanism in the loop sorter is actuated to send the item to the associated lane. Non-limiting examples of loop sorters include cross-belt sorters, shoe sorters, paddle sorters, pop-up transfer sorters (including lineshaft pop-up wheel sorters and pop-up steerable roller sorters), pusher sorters, puller sorters, shuttle sorters, and/or tilt tray sorters, to name just a few.

“Motor” generally refers to a machine that supplies motive power for a device with moving parts. The motor can include rotor and linear type motors. The motor can be powered in any number of ways, such as via electricity, internal combustion, pneumatics, and/or hydraulic power sources. By way of non-limiting examples, the motor can include a servomotor, a pneumatic motor, a hydraulic motor, a steam engine, pneumatic piston, hydraulic piston, and/or an internal combustion engine.

“Notch” generally refers to an indentation, cut, groove, channel, and/or incision on an edge or surface. In some non-limiting examples the notch includes a V-shaped or U-shaped indentation carved, scratched, or otherwise formed in the edge or surface. The notch can have a uniform shape or a non-uniform shape.

“Pin” or “Peg” generally refers to an elongated short piece of wood, metal, plastic and/or other material, typically (but not always) tapered at one end, that is used for holding things together, hanging things on, and/or marking a position. Typically, but not always, the pin is a small, usually cylindrical, pointed and/or tapered piece used to pin down, fasten things together and/or designed to fit into holes. In other examples, the pin can have a polyhedronal shape, such as with a rectangular or triangular cross-sectional shape, or an irregular shape.

“Sensor” generally refers to an object whose purpose is to detect events and/or changes in the environment of the sensor, and then provide a corresponding output. Sensors include transducers that provide various types of output, such as electrical and/or optical signals. By way of nonlimiting examples, the sensors can include pressure sensors, ultrasonic sensors, humidity sensors, gas sensors, motion sensors, acceleration sensors, displacement sensors, force sensors, optical sensors, and/or electromagnetic sensors. In some examples, the sensors include barcode readers, RFID readers, and/or vision systems.

“Shoe”, “Pusher Shoe”, or “Pusher” generally refers to a device or structure that is designed to sort or divert items, such as packages, by moving the items generally in a lateral 3o direction relative to the bed of the sortation system. In one form, the shoe is slidably coupled to a slat. The shoe can be made from plastic or other suitable materials.

“Shoe Sorter”, “Slat Shoe Sorter”, “Slat Sorter”, or “Moving Slat Sorter” generally refers to a conveyor-based sortation system that includes a bed of slats to which shoes or pushers are attached. The slats in one example are coupled to a conveyor mechanism that recirculates the slats along a looped vertical and/or horizontal path. The shoes are configured slide relative to the slats such that the shoes are able to slide side-to-side relative to the bed to divert items to one or more lateral sides of the sorter. In one form, one or more shoes are attached to each slat, and in other forms, some of the slats do not have a shoe. In one example, as an item is inducted onto a shoe sorter, one or more corresponding shoes are assigned to each item, and when the item reaches the intended sortation lane, the one or more assigned shoes are switched to follow a track inside the sorter so as to push the item off the sorter and onto the intended sortation lane. In one form, multiple shoes gently divert the item in a diagonal direction from the sorter onto the intended diversion lane. The diagonal motion of the multiple shoes is used to avoid damaging items. Typically, but not always, shoe sorters are able to operate with a high throughput and are capable of reliably tracking and gently sorting a wide range and mix of items, including fragile items. In one example, the shoe sorter is configured to divert items to one side of the sorter, and in other examples, the shoe sorter is capable of diverting items to both sides of the sorter. Commonly, shoe sorters are incorporated into linear sorters (or linear sortation systems), but in some variations, the shoe sorters can be configured for use in circular sorters or loop sortation systems.

“Slat” generally refers to a long, thin narrow strip of material that is used as a support bed on a conveyor. Typically, but not always, the slats are made of a relatively smooth, lightweight material, such as metal, plastic, composite materials, and/or wood. In one form, the slats are made of aluminum.

“Sorter”, “Sorting System”, or “Sortation System” generally refers to a mechanical system or device which separates or organizes items (e.g., goods, luggage, mail, etc.) according to their destinations. A common type of sorter is a conveyor-based system, and although the sorters may be based on other conveyor systems, usually sorters are unique types of conveyors. In other examples, the sorters are not conveyor-based. For instance, sorters can include individually controllable shuttle type systems to perform sortation. Sorters in some examples are able to 3o accurately and efficiently sort, route, consolidate, and/or divert a wide range of parcel types to unique destinations for many purposes, including (but not limited to) the purpose of order selection, processing, packaging, palletizing, storing, and/or shipping. When the sorters are in the form of a conveyor, the individual units can be recirculated or looped in a horizontal and/or vertical direction. For instance, the sorters can include linear sortation systems (line sorters) and/or loop sortation systems (circle sorters). Non-limiting examples of sorters include cross-belt sorters, shoe sorters, paddle sorters, pop-up transfer sorters (including lineshaft pop-up wheel sorters and pop-up steerable roller sorters), pusher sorters, puller sorters, shuttle sorters, and/or tilt tray sorters, to name just a few.

“Stock Keeping Unit (SKU)” or “Item” generally refers to an individual article or thing. The SKU can come in any form and can be packaged or unpackaged. For instance, SKUs can be packaged in cases, cartons, bags, drums, containers, bottles, cans, pallets, and/or sacks, to name just a few examples. The SKU is not limited to a particular state of matter such that the item can normally have a solid, liquid, and/or gaseous form for example.

“Storage facility” generally refers to a location for keeping and/or storing items or goods. A storage facility may keep the items or goods indoors or outdoors. As an example, a storage facility may be a large building, such as a warehouse, or may be an outdoor area that is either open or enclosed by a fence or by another suitable method.

“Vision System” generally refers to one or more devices that collect data and form one or more images by a computer and/or other electronics to determine an appropriate position and/or to “see” an object. The vision system typically, but not always, includes an imaging-system that incorporates hardware and software to generally emulate functions of an eye, such as for automatic inspection and robotic guidance. In some cases, the vision system can employ one or more video cameras, analog-to-digital conversion (ADC), and digital signal processing (DSP) systems. By way of a non-limiting example, the vision system can include a charge-coupled device for inputting one or more images that are passed onto a processor for image processing. A vision system is generally not limited to just the visible spectrum. Some vision systems image the environment at infrared (IR), visible, ultraviolet (UV), and/or X-ray wavelengths. In some cases, vision systems can interpret three-dimensional surfaces, such as through binocular cameras.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A sortation system, comprising:
a slat; and
a shoe slidably disposed along the slat, wherein the shoe includes
a base having an exterior surface,
a bumper coupled to the base,
wherein the shoe is configured to move in a lateral direction along the slat to move an item across the slat, and
wherein the bumper is configured to deflect when a threshold force is applied indicative of a jam to allow the item to slide over the exterior surface of the base.

2. The system of claim 1, wherein:
the base is composed of a hard plastic; and
the bumper is composed of a flexible elastomeric material that bends when the threshold force is applied.

3. The system of claim 2 wherein the bumper is coupled to the base via an over-mold type connection.

4. The system of claim 1, wherein the base defines a bumper cavity configured to receive at least part of the bumper when deflected.

5. The system of claim 1, wherein the bumper has one or more support ribs extending from the bumper to the base that are configured to bend when the bumper is deflected.

6. The system of claim 5, wherein:
the bumper has one or more crumple cavities separated by one or more divider walls; and
the support ribs and the divider walls of the crumple cavities are arranged in an alternating manner.

7. The system of claim 1, wherein the exterior surface of the base includes:
an apex;
a leading edge;
a trailing edge located opposite the leading edge;
a pair of lateral edges extending transverse to the leading edge;
a pair of bumper edges extending diagonally between the lateral edges and the trailing edge;
a leading surface extending at an acute angle from the leading edge to the apex,
a trailing surface extending at an acute angle from the trailing edge towards the apex;
a pair of bumper surfaces extending at an acute angle from the bumper edges to the apex;
a pair of lateral surfaces extending from the lateral edges towards the apex at an acute angle; and
wherein the trailing surface and the lateral surfaces form truncated corner facets between the leading edge and the bumper edges.

8. The system of claim 7, wherein corners between adjacent edges are rounded.

9. The system of claim 1, wherein:
the base has an apex representing a highest part of the exterior surface relative to the slat; and
the bumper has a height that is at least as high as the apex of the base.

10. The system of claim 1, wherein:
the shoe includes a second bumper that is located opposite the bumper on the shoe; and
the bumper and the second bumper extend at an acute angle relative to one another.

11. The system of claim 1, further comprising:
wherein the slat defines a shoe guide slot;
a shoe guide slidably disposed in the shoe guide slot;
a fastener securing the base of the shoe to the shoe guide;
wherein the base defines a fastener opening in which the fastener is secured; and
wherein the fastener opening is positioned inboard relative to the bumper to allow the bumper to at least partially cover the fastener when the bumper is deflected.

12. The system of claim 1, further comprising:
a frame;
a drive system configured to move the slat in a longitudinal direction along the frame;
wherein the slat includes one or more slat pins;
a slat coupler coupling the slat to the drive system, wherein the slat coupler includes
a carriage base coupled to the drive system, wherein the carriage base has one or more pin notches;
a coupler arm pivotally coupled to the carriage base, wherein the coupler arm has one or more pin notches;
wherein the coupler arm is closed against the carriage base with the slat pins disposed within the pin notches of the carriage base and the coupler arm; and
a retainer clip clipped to the slat pins, wherein the retainer clip contacts the coupler arm to retain the coupler arm in a closed position where the coupler arm is closed against the carriage base.

13. A sortation system shoe, comprising:
a base having sloped sides, wherein the base is rigid; and
one or more bumpers extending from the base, wherein the bumpers are flexible to bend during a malfunction to allow an item to travel over the base.

14. The shoe of claim 13, wherein the bumpers include first and second bumpers extending in diverging directions on opposing sides of the bumper.

15. The shoe of claim 14, wherein the base includes:
an apex;
a leading edge;
a trailing edge located opposite the leading edge;
a pair of lateral edges extending transverse to the leading edge;
a pair of bumper edges extending diagonally between the lateral edges and the trailing edge;
a leading surface extending at an acute angle from the leading edge to the apex,
a trailing surface extending at an acute angle from the trailing edge towards the apex;
a pair of bumper surfaces extending at an acute angle from the bumper edges to the apex;
a pair of lateral surfaces extending from the lateral edges towards the apex at an acute angle; and
wherein the trailing surface and the lateral surfaces form truncated corner facets between the leading edge and the bumper edges.

16. The shoe of claim 15, wherein:
the base has the apex representing a highest part of the shoe; and
the bumper has a height that is at least as high as the apex of the base.

17. The shoe of claim 16, wherein the base defines one or more fastener openings positioned inboard relative to the bumpers to allow the bumpers to at least partially cover the fastener openings when the bumpers are deflected.

18. A system, comprising:
a frame;
a slat having one or more slat pins;
a drive system configured to move the slat in a longitudinal direction along the frame;
a slat coupler coupling the slat to the drive system, wherein the slat coupler includes
a carriage base coupled to the drive system, wherein the carriage base has one or more pin notches;
a coupler arm pivotally coupled to the carriage base, wherein the coupler arm has one or more pin notches; and
wherein the coupler arm is closed against the carriage base with the slat pins disposed within the pin notches of the carriage base and the coupler arm.

19. The system of claim 18, wherein:
the drive system includes a drive link with a drive pin; and
the carriage base includes
one or more wheels riding against the frame, and
a drive pin opening in which the drive pin of the drive system is received.

20. The system of claim 18, wherein:
the carriage base includes a hinge arm;
the hinge arm includes
a hinge shaft, and
a retention tab extending transverse from the hinge shaft at one end;
the coupler arm defines a hinge shaft opening with a key tab notch configured to receive the retention tab of the hinge shaft; and
the retention tab is configured to retain the coupler arm on the carriage base when the coupler arm is closed and to allow removal of the coupler arm when the key tab notch is aligned with the retention tab.

21. The system of claim 18, wherein:
the carriage base defines a base alignment notch proximal to one of the pin notches of the carriage base;
the coupler arm includes a retention tab received in the alignment notch to inhibit longitudinal movement of the coupler arm relative to the carriage base;
the carriage base defining an alignment groove that extends in the longitudinal direction; and
the coupler arm includes an alignment rail engaging the alignment groove in the carriage base to inhibit lateral movement of the coupler arm relative to the carriage base.

22. The system of claim 18, wherein the slat coupler includes:
a retainer clip clipped to the slat pins.

23. The system of claim 22, wherein the coupler arm defines a tool notch configured to receive a tool for prying the retainer clip from at least one of the slat pins.

24. The system of claim 22, wherein:
the slat pins include a first slat pin and a second slat pin; and
the retainer clip has a pin hook rotatably hooked to the first slat pin and a snap element snapped to the second slat pin.

25. The system of claim 24, wherein the coupler arm is pivotally coupled to the carriage base proximal to the snap element of the retainer clip.

26. The system of claim 25, wherein:
the coupler arm defines a tool notch configured to receive a tool for prying the retainer clip from at least one of the slat pins;
the retainer clip has a clip body and a flange that extends transverse to the clip body between the retainer clip and the snap element;
the flange overlaps with the tool notch; and
the tool notch is positioned proximal to the snap element.

27. The system of claim 24, wherein the pin hook and the snap elements have pin openings that open transverse relative to one another.

28. The system of claim 24, wherein:
the carriage base has a detent located proximal to the first slat pin; and
the pin hook has a detent notch engaged to the detent to inhibit accidental rotation of the pin hook.

29. The system of claim 22, wherein the retainer clip contacts the coupler arm to retain the coupler arm in a closed position where the coupler arm is closed against the carriage base.

30. The system of claim 22, wherein the retainer clip retains the slat and the coupler arm in a lateral direction.

31. The system of claim 22, wherein the pins have one or more clip ridges and grooves to inhibit lateral movement of the retainer clip.

32. The system of claim 18, further comprising:
a shoe coupled to the slat, the shoe including one or more bumpers extending from the base, wherein the bumpers are configured to bend.

33. A method, comprising:
diverting an item with a shoe of a sortation system, wherein the shoe includes a base that has one or more sloped sides and a bumper that extends from the base;
deflecting the bumper during a malfunction; and
moving the shoe underneath the item with the item sliding over the sloped sides.

34. The method of claim 33, further comprising:
conveying a slat in a longitudinal direction of the sortation system, wherein the slat supports the shoe; and
wherein said diverting includes moving the shoe along the slat in a lateral direction of the sortation system.

35. A method, comprising:
placing one or more slat pins in one or more corresponding slat pin notches in a carriage base, wherein the slat pins extend from a slat;
pivoting a coupler arm that is pivotally coupled to the carriage base to a closed position where the slat pins are sandwiched between the coupler arm and the carriage base; and
clipping a retainer clip to the slat pins to retain the coupler arm in the closed position.

36. The method of claim 35, further comprising:
wherein the slat pins include a first slat pin and a second slat pin; and
wherein said clipping includes
hooking a pin hook of the retainer clip to the first slat pin and
snapping a snap element of the retainer clip onto the second slat pin.
